(19) United States
(12) Patent Application Publication
(10) Pub. No.: US 2007/0078883 A1
(43) Pub. Date: Apr. 5, 2007

(54) Using location tags to render tagged portions of media files

(75) Inventors: Nathanael Joe Hayashi, Piedmont, CA (US); Matt Fukuda, San Francisco, CA (US)

Correspondence Address: James J. DeCarlo;GREENBERG TRAURIG, LLP, MetLife Building, 200 Park Avenue, New York, NY, 10166, US

(73) Assignee: Yahoo! Inc., Sunnyvale, CA (US)

(21) Appl. No.: 11/341,976

(22) Filed: Jan. 27, 2006

Related U.S. Application Data
(60) Provisional application No. 60/722,600, filed on Sep. 30, 2005.

(51) Int. Cl. G06F 7/00

(52) U.S. Cl. 707/102

(57) ABSTRACT

A system and method are provided for identifying discrete locations and/or sections within a pre-existing media file without modifying the media file. The discrete locations and/or sections can be associated with one or more user-selected descriptors. The system and method allows for the identifying information to be communicated to consumers of the media file and the media file to be selectively rendered by the consumer using the identifying information, thus allowing a consumer to render only the portion of the media file identified or render from a given discrete location in the media file. In an embodiment, the system and method can be performed without modifying the media file itself and thus no derivative work is created.

### RELATED APPLICATIONS

This application claims the benefit of U.S. Provisional Application No. 60/722,600, filed Sep. 30, 2005 which application is hereby incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Multimedia data files, or media files, are data structures that may include audio, video or other content stored as data in accordance with a container format. A container format is a file format that can contain various types of data, possible compressed a standardized and known manner. The container format allows a rendering device to identify, and if necessary, interleave, the different data types for proper rendering. Some container formats can contain only audio data, while other container formation can support audio, video, subtitles, chapters and metadata along with synchronization information needed to play back the various data streams together. For example, an audio file format is a container format for storing audio data. There are many audio-only container formats including known in the art including WAV, AIFF, FLAC, ACC, WMA, and MP3. In addition, there are now a number of container formats for use with combined audio, video and other content including AVI, MOV, MPEG-2 TS, MP4, ASF, and RealMedia to name but a few.

Media files accessible over a network are increasingly being used to deliver content to mass audiences. For example, one emerging way of periodically delivering content to consumers is through podcasting. A podcast is a file, referred to as a “feed,” that lists media files that are related, typically each media file being an “episode” in a “series” with a common theme or topic published by a single publisher. Content consumers can, through the appropriate software, subscribe to a feed and thereby be alerted to or even automatically obtain new episodes (i.e., new media files added to the series) as they become available.

Podcasting illustrates one problem with using media files to deliver mass media through discrete media files. Often, it is desirable to identify a discrete section or sections within a media file. For example, a content consumer may want to identify a section of a news broadcast as particularly of interest or as relating to a topic such as “weather forecast,” “sports,” or “politics.” This is a simple matter for the initial creators of the content, as various data formats support such identifications within the file when the media file is created.

However, it is difficult with current technology to identify a section or sections within a media file after the file has been initially created. In the past, one method of doing this was to edit the media file into smaller portions and place the topic information into the new file name of the smaller portions. Another method is to create a derivative of the original file by editing the file to include additional information identifying the discrete section information.

The methods described above for identifying sections in a pre-existing media file have a number of drawbacks. First, it requires significant effort to edit the media file, whether that be into separate, smaller files or a derivative file with additional information. Second, separate files must be played individually and the sequential relationship to the original master file may be lost. Third, the methods require that the user have the appropriate rights under copyright to make the derivative works. Fourth, now that this new media has been created, is not easily available to the mass market and therefore of limited use.

### SUMMARY OF THE INVENTION

Various embodiments of the present invention relate to a system and method for identifying discrete locations and/or sections within a pre-existing media file without modifying the media file. The discrete locations and/or sections can be associated with one or more user-selected descriptors. The system and method allows for the identifying information to be communicated to consumers of the media file and the media file to be selectively rendered by the consumer using the identifying information, thus allowing a consumer to render only the portion of the media file identified or render from a given discrete location in the media file. In an embodiment, the system and method can be performed without modifying the media file itself and thus no derivative work is created.

In one example (which example is intended to be illustrative and not restrictive), the present invention may be considered a method of rendering a portion of media data within a media file, in which the portion excludes at least some of the media data within the media file. The method includes accessing a portion definition associated with the media file, the portion definition identifying the portion of media data within the media file to be rendered. The media file is accessed and, in response to a command to render the media file in accordance with the portion definition, rendered by the rendering device such that only the portion of media data is rendered.

In one example (which example is intended to be illustrative and not restrictive), an embodiment of the present invention can be thought of as a method for creating a portion definition in which a media file containing media data is rendered to a user. One or more user inputs are received from the user in which the user inputs identify a portion of the media file, the portion excluding at least some of the media data of the media file. In response to the user inputs, a portion definition is created and associated with the media file, wherein the portion definition includes metadata based on the one or more user inputs received, the metadata identifying the portion of the media data.

In one example (which example is intended to be illustrative and not restrictive), the present invention may be considered a method of using a client-server system for rendering only a portion of a media file matching a search criterion. In the method, at least one portion definition is maintained on a computing device in a searchable data store. The portion definition identifies a portion of media data of an associated media file in which each portion excludes at least some of the media data of the associated media file. The portion definition also includes tag information describing the portion to potential consumers. A search request is received from a rendering device remote from the computing device, in which the request contains a criterion matching the tag information in the portion definition. A response identifying the portion of the media file as containing media data matching the search criterion is then transmitted to the rendering device the response. In addition, at least some of the portion definition from the searchable data store is also transmitted to the rendering device.

In one example (which example is intended to be illustrative and not restrictive), the present invention may be considered a method for consecutively rendering portions of pre-existing media files without creating a tangible derivative work of the pre-existing media files. In the method, a composite representation is received that includes data identifying a plurality of different portions, each portion associated with a different media file. A command is received to render the composite representation on a rendering device. In response, the rendering device consecutively renders each of the plurality of different portions in response to the command by retrieving the media files and rendering only the media data identified by each portion.

Additional features of the invention will be set forth in the description which follows, and in part will be apparent from the description, or may be learned by practice of the invention. The various features of the invention will be realized and attained by the structure particularly pointed out in the written description and claims hereof as well as the appended drawings. It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a flowchart of an embodiment of a high-level method of rendering a portion of a pre-existing media file.

FIG. 2 is an illustration of a network architecture of connected computing devices as might be used to distribute and render media files in accordance with one or more embodiments of the present invention.

FIG. 3 is a flowchart of another embodiment of a high-level method of rendering a portion of a pre-existing media file.

FIG. 4 is a flowchart of an embodiment of a method of creating a portion definition identifying a portion of a pre-existing media file.

FIG. 5 is a flowchart of an embodiment of a method of rendering only a portion of a pre-existing media file.

FIG. 6 is a flowchart of an embodiment of a method of categorizing portions of pre-existing media files for selective rendering.

FIG. 7 is a flowchart of an embodiment of a method of collecting information identifying portions of pre-existing media files.

FIG. 8 is an embodiment of a method of rendering a composite representation.

FIG. 9 is an example of an embodiment of a data structure of a composite representation.

FIG. 10 is an embodiment of a method of creating a composite representation.

FIG. 11 is an illustration of an embodiment of a graphical user interface of a rendering device.

FIG. 12 is an illustration of an embodiment of a graphical user interface of a rendering device showing the results of a search for portions of media files.

FIG. 13 is an illustration of an embodiment of a graphical user interface of a rendering device during rendering portions of media files.

FIG. 14 is a flowchart of an embodiment of a method of rendering a media file using metadata to begin rendering the media file from the last location rendered.

FIG. 15 is a flowchart of an embodiment of a method of filemarking a pre-existing media file without modifying the media file.

### DETAILED DESCRIPTION OF EMBODIMENTS OF THE INVENTION

Reference will now be made in detail to illustrative embodiments of the present invention, examples of which are shown in the accompanying drawings.

An embodiment of the present invention includes a system and method for identifying discrete locations and/or sections within a pre-existing media file without modifying the media file. The discrete locations and/or sections can be associated with one or more user-selected descriptors. The system and method allows for the identifying information to be communicated to consumers of the media file and the media file to be selectively rendered by the consumer using the identifying information, thus allowing a consumer to render only the portion of the media file identified or render from a given discrete location in the media file. In an embodiment, the system and method can be performed without modifying the media file itself and thus no derivative work is created.

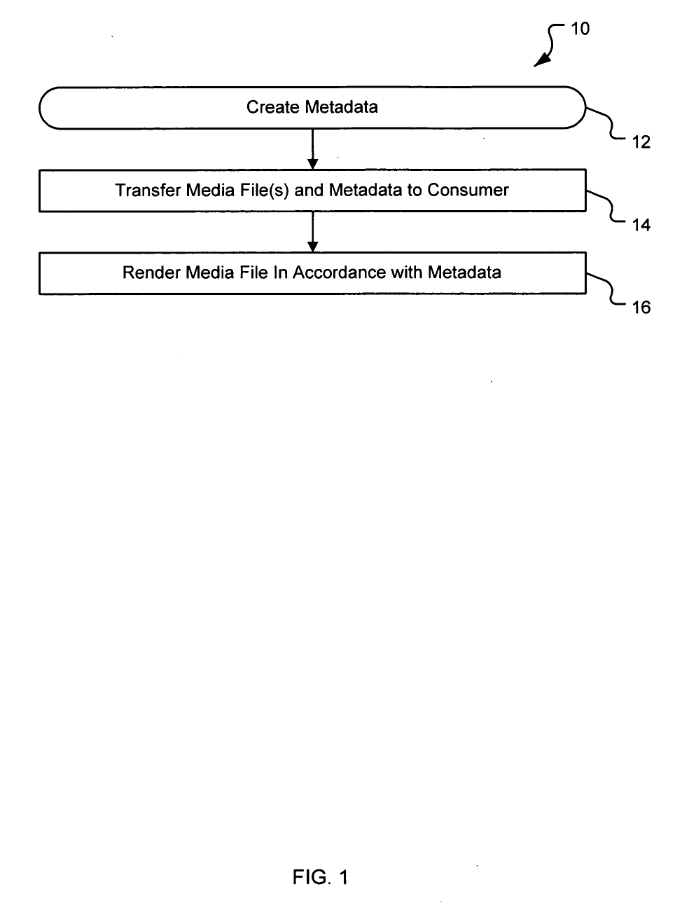

FIG. 1 is a high-level illustration of an embodiment of a method of rendering a portion of a pre-existing media file. In the method 10, a portion definition is created that identifies either a discrete location in the media file or a section within the media file in a create portion definition operation 12. As discussed in greater detail below, in an embodiment the portion definition in the form of metadata is created using a rendering device adapted to create the metadata in response to inputs received from the metadata creator during rendering of the media file. The creator may render the media file on a rendering device, such as using a media player on a computing device or a digital audio player, that is adapted to provide a user interface for generating the portion definition in response to the creator's inputs.

As also discussed in greater detail below, the portion definition may take many different forms and may include identification metadata that serves to identify a section or location within a pre-existing media file without changing the format of the media file. Thus, a portion definition may be considered as identifying a subset of the media data within a media file, the subset being something less than all of the media data in the media file. For example, identification metadata including a time stamp indicating a time measured from a known point in the media file such as the beginning or end point of the media file. Alternatively, the metadata may identify an internal location identifier in a media file that contains data in a format that provides such internal location identifiers. In yet another alternative embodiment, metadata may include a number, in which the number is multiplied by a fixed amount of time, such as 0.5 seconds for example, or a fixed amount of data, such as 2,352 bytes or one data block for example. In this embodiment, a selection made by the creator results in the next or closest number of the fixed unit is selected for the metadata. One skilled in the art will recognize that various other methods or systems may be used to identify locations in a pre-existing media file, the suitability of which will depend upon the implementation of other elements of the system as a whole.

As mentioned above, the metadata may identify a discrete location in the media file (and thus may be considered to identify the portion of the media file that consists of all the media data in the media file from the discrete location to the end of the media file) or identify any given section contained within a media file as directed by the portion definition creator. Thus, in an embodiment metadata in a portion definition may include a time stamp and an associated duration. Alternatively, the metadata may include two associated time stamps, e.g., a start and a finish. Other embodiments are also possible and within the scope of the present invention as long as the metadata can be used to identify a point or location within a pre-existing media file.

As discussed in greater detail below, the creator of the portion definition may also choose to associate the location identified with the metadata with a user-selected descriptor, such as word or phrase. These descriptors may be referred to as “tags” for simplicity. For example, the word “weather” may be used as a tag to refer to a section of a media file containing a new report, in which the section is the local weather forecast. One or more tags may be associated with any given metadata section or location identifier. Depending on the implementation, the tag or tags themselves may be considered a separate and distinguishable element of the metadata.

The metadata may also include other information for describing the portion of the media file identified by the metadata. For example, user reviews and rating to be associated with only the identified portion of the media file may be included in the metadata. This information may be as additional information that can be searched and used to identify the underlying content in the portion's media data. The information may also be displayed to consumers during searching or rendering of the identified portion.

More that one set of metadata may be created and associated with a media file and associated with different tags. Each set of metadata may then independently identify different portions of the same media file. The portions are independently identified in that any two portions may overlap, depending on the creators designation of beginning and end points.

The metadata created by the metadata creator is then stored in some manner. Storage may include storing the metadata as a discrete file or as data within some other structure such as a request to a remote computing device, a record in a database, or an electronic mail message. The metadata may positively identify the pre-existing media file through the inclusion of a media file identifier containing the file name of the media file. Alternatively, the metadata may be associated with the media file through proximity in that the media file information and the metadata information must be provided together as associated elements, such as in hidden text in a hyperlink. In yet another alternative, the metadata may be stored in a database as information associated with the media file. In an embodiment, all metadata for a discrete media file may be collected into a single data element, a group of data elements, a database, or a file depending on the implementation of the system.

In order for a consumer to render the identified section of the media file, in the embodiment shown the metadata and the media file are made available to the consumer's rendering device in an access media file and metadata operation 14. In an embodiment, the metadata may be transmitted to the consumer's rendering device via an e-mail containing the metadata and a link to the media file on a remote computer. The rendering device is adapted to read the metadata in the e-mail and retrieve the media file identified in the link in a subsequent rendering operation 16. In that way, the rendering device in the rendering operation 16 renders the media file starting from the identified starting point. If the metadata identified a section of the media file, rendering may automatically cease at the end of the section, instead of rendering to the end of the media file. If the metadata identifies only a discrete location in the media file, the rendering operation 16 results in starting the rendering of the media file at the identified location and renders until either a consumer command ends the rendering or the end of the media file is reached.

In an alternative embodiment the metadata is transmitted to the consumer's rendering device as a metadata file. The metadata file is readable by the rendering device in response to a command to render the file. Such a command to render the metadata file may result in the rendering device obtaining the associated media file and rendering, in a rendering operation 16, the media file in accordance with the metadata.

The access media file and metadata operation 14 and the rendering operation 16 may occur in response to a consumer command to render the pre-existing media file in accordance with the metadata, e.g., render the section of the media file tagged as “weather.” Alternatively, none of or only some portion of the copy media file and metadata operation 14 may occur prior to an actual receipt of a consumer command to render the media file in accordance with the metadata.

Rendering operation 16 may also include displaying additional information to the consumer associated with the point or section being rendered. Such information may be obtained directly from the metadata or may be associated with the metadata in a way that allows the information to be identified and accessed by the rendering device. For example, in an embodiment the information is the tag and the rendering operation 16 includes displaying the tag to the consumer. Such information may need to be extracted from the metadata or from some other computing device identified or associated with the metadata.

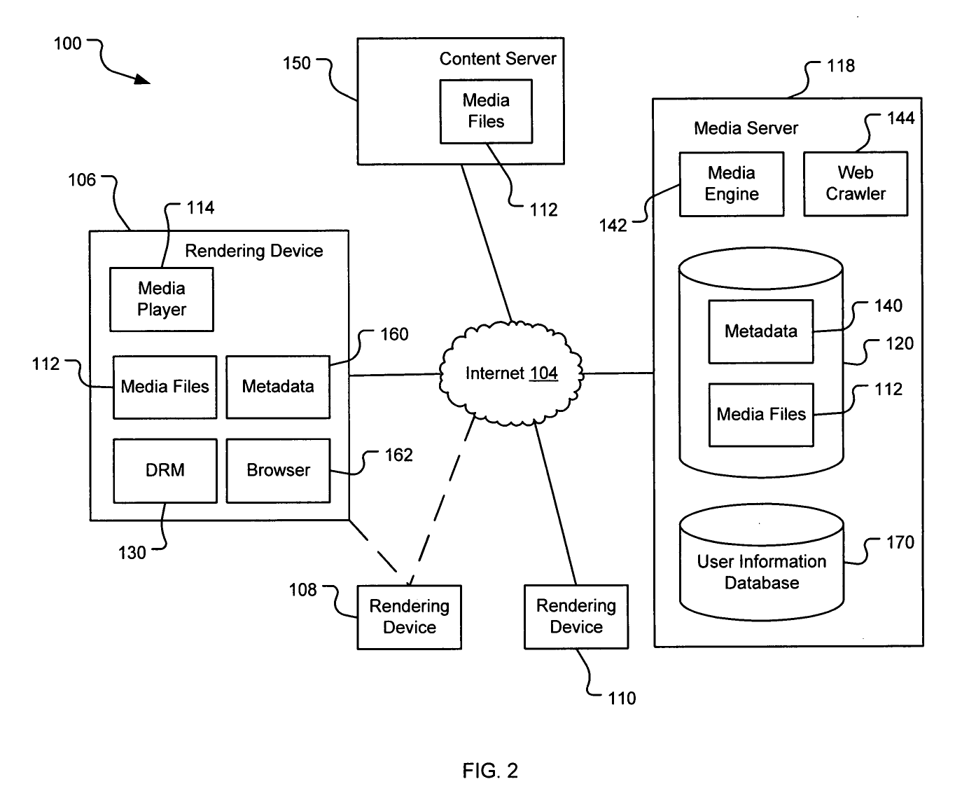

FIG. 2 is an illustration of a network architecture of connected computing devices as might be used to distribute and render media files. In the architecture 100, the various computing devices are connected via a network 104. One example of a network 104 is the Internet. Another example is a private network of interconnected computers.

The architecture 100 further includes a plurality of devices 106, 108, 110, referred to as rendering devices 106, 108, 110, capable of rendering media files 112 or rendering streams of media data of some format. Many different types of devices may be rendering devices, as long as they are capable of rendering media files or streaming media. A rendering devices may be a personal computer (PC), web enabled cellular telephone, personal digital assistant (PDA) or the like, capable of receiving media data over the network 104, either directly or indirectly (i.e., via a connection with another computing device).

For example, as shown in FIG. 2, one rendering device is a personal computer 106 provided with various software modules including a media player 114, one or more media files 112, metadata 160, a digital rights management engine 130 and a browser 162. The media player 114, among other functions to be further described, provides the ability to convert information or data into a perceptible form and manage media related information or data so that user may personalize their experience with various media. Media player 114 may be incorporated into the rendering device by a vendor of the device, or obtained as a separate component from a media player provider or in some other art recognized manner. As will be further described below, it is contemplated that media player 114 may be a software application, or a software/firmware combination, or a software/firmware/hardware combination, as a matter of design choice, that serves as a central media manager for a user of the rendering device and facilitates the management of all manner of media files and services that the user might wish to access either through a computer or a personal portable device or through network devices available at various locations via a network.

The browser 162 can be used by a consumer to identify and retrieve media files 112 accessible through the network 104. An example of a browser includes software modules such as that offered by Microsoft Corporation under the trade name INTERNET EXPLORER, or that offered by Netscape Corp. under the trade name NETSCAPE NAVIGATOR, or the software or hardware equivalent of the aforementioned components that enable networked intercommunication between users and service providers and/or among users. In an embodiment, the browser 162 and media player 114 may operate jointly to allow media files 112 or streaming media data to be rendered in response to a single consumer input, such as selecting a link to a media file 112 on a web page rendered by the browser 162.

Another example of a rendering device is a music player device 108 such as an MP3 player that can retrieve and render media files 112 directly from a network 104 or indirectly from another computing device connected to the network 104. One skilled in the art will recognize that a rendering device 106, 108, 110 may be configured in many different ways and implemented using many different combinations of hardware, software, or firmware.

A rendering device, such as the personal computer 106, also may include storage of local media files 112 and/or other plug-in programs that are run through or interact with the media player 114. A rendering device also may be connectable to one or more other portable rendering devices that may or may not be directly connectable to the network 104, such as a compact disc player and/or other external media file player, commonly referred to as an MP3 player, such as the type sold under the trade name iPod by Apple Computer, Inc., that is used to portably store and render media files. Such portable rendering devices 108 may indirectly connect to the media server 118 and content server 150 through a connected rendering device 106 or may be able to connect to the network 104, and thus directly connect to the computing devices 106, 118, 150, 110 on the network. Portable rendering devices 108 may implement location tagging by synchronizing with computing devices 118, 150, 110 on the network 104 whenever the portable rendering devices 108 is directly connected to a computing device in communication with the network 104. In an embodiment, any necessary communications may be stored and delayed until such a direct connection is made.

A rendering device 106, 108, 110 further includes storage of portion definitions, such as in the form of metadata 160. The portion definitions may be stored as individual files or within some other data structure on the storage of the rendering device or temporarily stored in memory of the rendering device for use when rendering an associated media file 112.

The architecture 100 also includes one or more content servers 150. Content servers 150 are computers connected to the network 104 that store media files 112 remotely from the rendering devices 106, 108, 110. For example, a content server 150 may include several podcast feeds and each of the media files identified by the feeds. One advantage of networked content servers is that as long as the location of a media file 112 is known a computing device with the appropriate software can access the media file 112 through the network 104. This allows media files 112 to be distributed across multiple content servers 150. It also further allows for a single “master” media file to be maintained at one location that is accessible to the mass market and thereby allow the publisher to control access. Through the connection to the network 104, rendering devices 106, 108, 110 may retrieve, either directly or indirectly, the media files 112. After the media files 112 are retrieved, the media files 112 may be rendered to the user, also known as the content consumer, of the rendering device 106, 108, 110.

In an embodiment, media files can be retrieved from a content server 150 over a network 104 via a location address or locator, such as a uniform resource locator or URL. An URL is an example of a standardized Internet address usable, such as by a browser 162, to identify files on the network 104. Other locators are also possible, though less common.

The embodiment of the architecture 100 shown in FIG. 2 further includes a media server 118. The media server 118 can be a server computer or group of server computers connected to the network 104 that work together to provide services as if from a single network location or related set of network locations. In a simple embodiment, the media server 118 could be a single computing device such as a personal computer. However, in order to provide services on a mass scale to multiple rendering devices, an embodiment of a media server 118 may include many different computing devices such as server computers, dedicated data stores, routers, and other equipment distributed throughout many different physical locations.

The media server 118 may include software or servers that make other content and services available and may provide administrative services such as managing user logon, service access permission, digital rights management, and other services made available through a service provider. Although some of the embodiments of the invention are described in terms of music, embodiments can also encompass any form of streaming or non-streaming media data including but not limited to news, entertainment, sports events, web page or perceptible audio or video content. It should be also be understood that although the present invention is described in terms of media content and specifically audio content, the scope of the present invention encompasses any content or media format heretofore or hereafter known.

The media server 118 may also include a user database 170 of user information. The user information database 170 includes information about users that is collected from users, such as media consumers accessing the media server 118 with a rendering device, or generated by the media server 118 as the user interacts with the media server 118. In one embodiment, the user information database 170 includes user information such as user name, gender, e-mail and other addresses, user preferences, etc. that the user may provide to the media server 118. In addition, the server 118 may collect information such as what podcasts the user has subscribed to, what media files the user has listened to, what searches the user has performed, how the user has rated various podcasts, etc. In effect, any information related to the user and the media that a user consumes may be stored in the user information database 170.

The user information database 170 may also include information about a user's rendering device 106, 108 or 110. The information allows the media server 118 to identify the rendering device by type and capability.

Media server 118 includes or is connected to a media database 120. The database 120 may be distributed over multiple servers, discrete data stores, and locations. The media database 120 stores various metadata 140 associated with different media files 112 on the network 104. The media database 120 may or may not store media files 112 and for the purposes of this specification it is assumed that the majority, if not all, of the media files 112 of interest are located on remote content servers 150 that are not associated with the media server 118. The metadata 140 may include details about the media file 112 such as its location information, in the form of a URL, with which the media file 112 may be obtained. In an embodiment, this location information may be used as a unique ID for a media file 112.

The metadata 140 stored in the media database 120 includes metadata for portion definitions associated with media files 112. In an embodiment, portion definitions include metadata 140 received by the media engine 142 from users who may or may not be associated with the publishers of the pre-existing media files 112. The metadata of the portion definitions created for pre-existing media files 112 may then be stored and maintained centrally on the media server 118 and thus made available to all users.

To gather and maintain some of the metadata 140 stored in the media database 120, the media server 118 includes a web crawler 144. The web crawler 144 searches the network 104 and may retrieve or generate metadata associated with media files 112 that the web crawler identifies. In many cases, the metadata 140 identified and retrieved by the web crawler 144 for each media file 112 will be metadata provided by the publisher or creator of the original media file 112.

In the embodiment shown, the web crawler 144 may periodically update the information stored in the media database 120. This maintains the currency of data as the server 118 searches for new media files 112 and for media files 112 that have been moved or removed from access to the internet 104. The media database 120 may include all of the information provided by the media file 112 by the publisher. In addition, the media database 120 may include other information, such as portion definitions, generated by consumers and transmitted to the media server 118. Thus, the media database 120 may contain information not known to or generated by the publisher of a given media file 112.

In an embodiment, the media database 120 includes additional information regarding media files 112 in the form of “tags.” A tag is a keyword chosen by a user to describe a particular item of content such as a feed, a media file 112 or portion of a media file 112. The tag can be any word or combination of key strokes. Each tag submitted to the media server may be recorded in the media database 120 and associated with the content the tag describes. Tags may be associated with a particular feed (e.g., a series tag), associated with a specific media file 112 (e.g., an episode tag) or an identified portion of a media file 112. Tags will be discussed in greater detail below.

Since tags can be any keyword, a typical name for a category, such as “science” or “business,” may also be used as a tag and in an embodiment the initial tags for a media file 112 are automatically generated by taking the descriptions contained within metadata within a pre-existing media file 112 and using them as the initial tags for the media file 112. However, note that tags need not be a hierarchical category system that one “drills down” through. Tags are not hierarchically related as is required in the typical categorization scheme. Tags are also cumulative in that the number of users that identify a series or an episode with a specific tag are tracked. The relative importance of the specific tag as an accurate description of the associated content (i.e., series, episode, media file or portion of media file) is based on the number of users that associated that tag with the content.

In an embodiment, consumers of media files 112 are allowed to provide information to be associated with the media file 112 or a portion of the media file 112. Thus the user after consuming media data may rate the content, say on a scale of 1-5 stars, write a review of the content, and enter tags to be associated with the content. All this consumer-generated data may be stored in the media database 120 and associated with the appropriate media file 112 for use in future searches.

In one embodiment, the media engine 142 creates a new entry in the media database 120 for every media file 112 it finds. Initially, the entry may contain some or all of the information provided by the media file 112 itself. An automatic analysis may or may not be performed to match the media file 112 to known tags based on the information provided in the media file 112. For example, in an embodiment some media files 112 include metadata such as a category element and the categories listed in that element for the media file 112 are automatically used as the initial tags for the media file 112. While this is not the intended use of the category element, it is used as an initial tag as a starting point for the generation of more accurate tags for the media file 112. Note that searches on terms that appear in the media file 112 metadata will return that media file 112 as a result, so it is not necessary to provide tags to a new entry for the search to work properly. Initially no ratings information or user reviews are associated with the new entry. The manager of the media server may solicit additional information from the publisher such as the publisher's recommended tags and any additional descriptive information that the publisher wishes to provide but did not provide in the media file 112 itself.

The media database 120 may also include such information as reviews of the quality of the feeds, including reviews of a given media file 112. The review may be a rating such as a “star” rating and may include additional descriptions provided by users. The media database 120 may also include information associated with publishers of the media file 112, sponsors of the media file 112, or people in the media file 112.

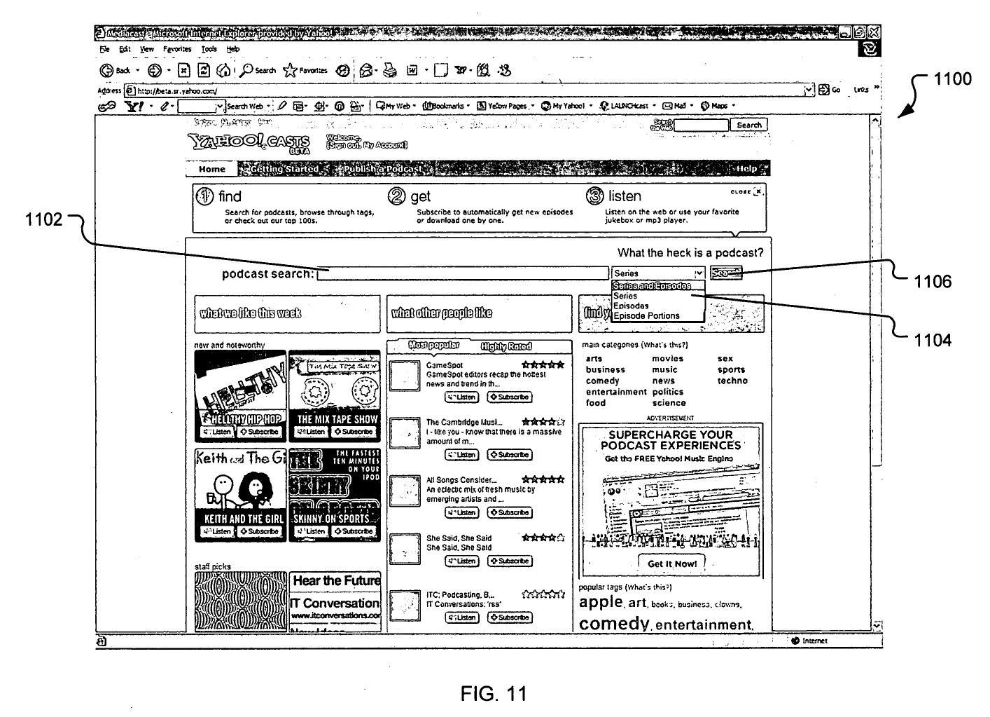

The media server 118 includes a media engine 142. In an embodiment, the media engine 142 provides a graphical user interface to users allowing the user to search for and render media files 112 and portions of media files 112 using the media server 118. The graphical user interface may be an .HTML page served to a rendering device for display to the user via a browser. Alternatively the graphical user interface may be presented to the user through some other software on the rendering device. Examples of a graphical user interface presented to a user by a browser are discussed with reference to FIGS. 11-13. Through the graphical user interface, the media engine 142 receives user search criteria. The search engine 142 then uses these parameters to identify media files 112 or portions of media files 112 that meet the user's criteria. The search may involve an active search of the network, a search of the media database 120, or some combination of both. The search may include a search of the descriptions provided in the media files 112. The search may also include a search of the tags and other information associated with media files 112 and portions of the media files 112 listed in the media database 120, but not provided by the media files themselves. The results of the search are then displayed to the user via the graphical user interface.

In one embodiment of the present invention, similar to the DRM software 130 located on a rendering device 106, the media server may maintain its own DRM software (not shown) which tracks the digital rights of media files located either in the media database 120 or stored on a user's processor. Thus, for example, before the media server 118 streams or serves up or transfers any media files to a user, it validates the rights designation of that particular piece of media and only serves streams or transfers the file if the user has the appropriate rights.

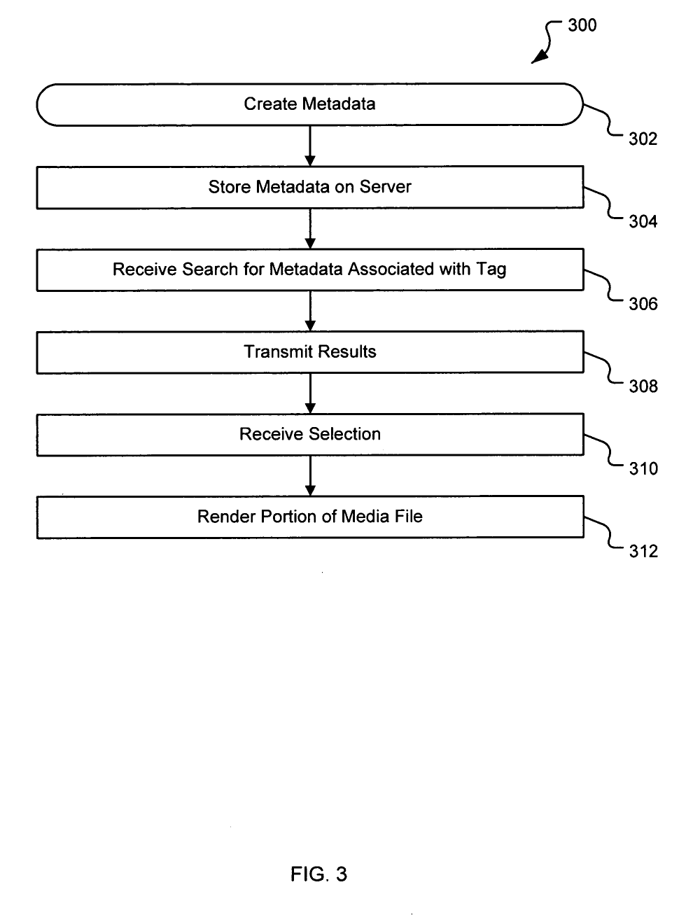

FIG. 3 is a flowchart of another embodiment of a high-level method of rendering a portion of a pre-existing media file. In the method 300 shown, a media server is used to manage the metadata created by the creator.

The method 300 starts with the creation of a portion definition in a creation operation 302. Again, the metadata of the portion definition contains the information necessary to identify a location or section within the pre-existing media file. In an embodiment, the creation operation 302 may involve creating the metadata at a creator's computing device. For example, the metadata may be generated by a media player in response to the creator's commands. The metadata will then be, at least temporarily, stored on the creator's computing device before it can be transmitted to the media server.

In an alternative embodiment, the creator interfaces with a server-side module, such as a media engine, via a browser or purpose-built media engine user interface on the creator's computing device. The creator's commands, entered through the browser or interface, are transmitted to the media server via a client-server communication protocol, such as via HTTP requests or remote procedure calls (RPCs). In this alternative, the metadata is then created at the media server based on the communications received from the creator's computing device.

After the creation operation 302, the metadata is stored on a storage device accessible to the media server in a store operation 304. In an embodiment, the metadata is stored in a database accessible through the media engine on the server. If the metadata does not identify the associated media file, then the metadata is stored in a way that associates it with the media file.

In addition to storing the metadata, some descriptor such as a tag may also be stored and associated with the metadata and the media file, as described above. Again, in alternative embodiments such tags may be considered a part of the metadata or a separate element depending on the implementation.

After storage, the metadata of the portion definition is then available to a consumer for use. In an embodiment, a consumer may find the metadata via interfacing with the media engine on the media server. The media engine allows the consumer to search for media files having metadata associated with the tag. Thus, the tag or tags associated with metadata can be used as indexing criteria allowing portions of pre-existing media files to be associated with different tags.

In the method 300, a consumer identifies a given location or section in a media file by sending, from the consumer's rendering device, a search request with search criteria. The search request is received by the media server in a receive search operation 306. In response to the search request, the media engine on the media server searches the metadata for metadata associated with the search criteria. For example, the search request may be limited by the criteria so as to identify only portions of media files associated with the word “weather.” In response, the media server would create a list of media files associated with portion definitions having the tag “weather.”

Some or all of the list would then be transmitted to the consumer in a transmit search results operation 308. The list may be transmitted as part of a web page that is displayed to the consumer via the consumer's browser. Alternatively, the results may be transmitted in a format that is interpretable by a software on the consumer's rendering device associated with the media engine.

The consumer then may select an entry from the list in the results, such selection being received by the media server in a receive selection operation 310. Note that in this embodiment, the selection is a command to render the portion of the selected media file associated with the search criteria identified in the receive search operation 306.

In response to the selection, the media engine causes the media file to be rendered on the consumer's rendering device in accordance with the metadata associated with the search criteria in an rendering operation 312. In an embodiment, the rendering operation 312 may include transmitting the metadata and the media file to the rendering device from the media server. In this case, the media server may act as a proxy for the media file by locally storing a copy or may obtain the media file from a remote server. Again, the metadata may be transmitted in any form interpretable by the rendering device, such as in a dedicated metadata file or as part of a page of data.

In an alternate embodiment, the rendering operation 312 may include transmitting the metadata associated with the search criteria to the consumer's rendering device along with information that allows the rendering device to obtain the media file directly from a remote server. The rendering device then renders the media file after it is obtained in accordance with the metadata.

In yet another embodiment, the media server retrieves the media file and, using the metadata, generates and transmits to the rendering device only a stream of multimedia data corresponding to the portion of the media file identified by the metadata. The multimedia data stream may then be rendered by the rendering device as it is received or stored for future rendering. This has a benefit that the entire media file need not be transmitted to and received by the consumer's rendering device when the consumer only wishes to render a portion of the media file. If the media file is very large and the portion of interest is small, this represents a significant improvement in the use of resources to render the portion of interest. This also allows the rendering device to be simpler, as the rendering device need not be capable of interpreting the metadata to render only the identified portion of the media file.

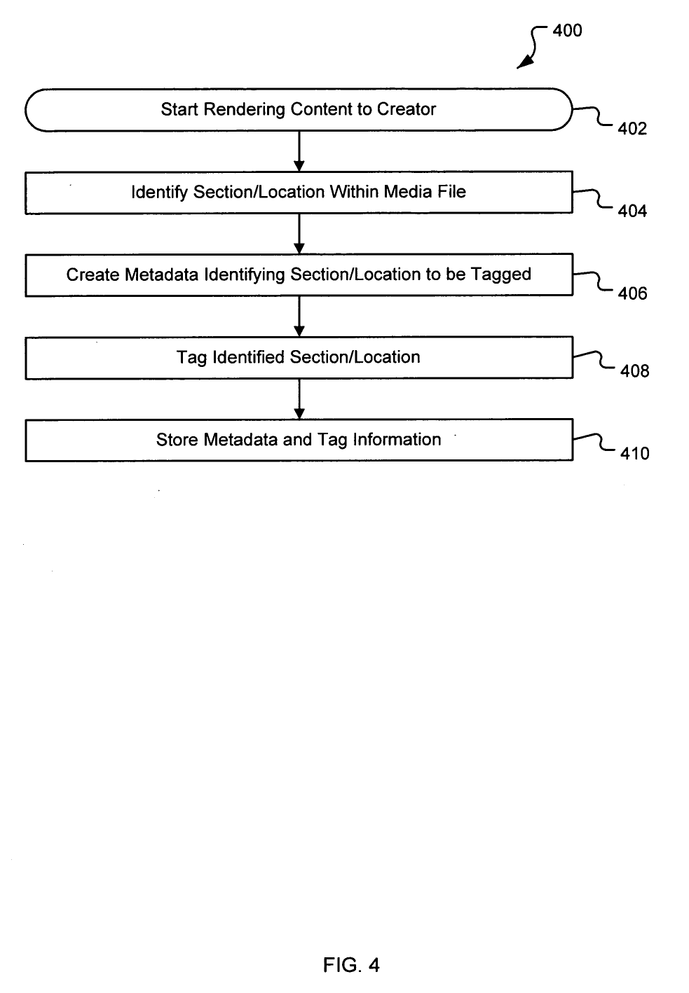

FIG. 4 is a flowchart of an embodiment 400 of a method of creating a portion definition, in the form of metadata, identifying a portion of a pre-existing media file. In the method 400 shown, the creator starts play back of a selected media file using a rendering device capable of capturing the metadata in an initiate rendering operation 402.

During the rendering, the creator issues a request to the rendering device to identify a portion of the media file in an identify portion operation 404. In an embodiment, the identify portion operation 404 includes receiving a first command from the creator during rendering of the media file identifying the starting point and receiving a second command from the creator identifying an endpoint of the portion of the media file.

In an alternative embodiment, the creator issues a request to the rendering device to identify a location of the media file in an identify portion operation 404. In this embodiment, only a first command from the creator is received during rendering of the media file identifying the location point within the media file.

From these commands and information provided by the creator, the metadata may be created in a create metadata operation 406. Depending on the implementation, the metadata may be created on creator's rendering device or created on a media server remote from the rendering device as discussed above.

The identified portion may be associated with some description in a tag operation 408. In an embodiment, the rendering device may prompt the creator to enter one or more tags to be associated with the identified portion. In an alternative embodiment, the creator may enter the tag as part of an initial request to create a portion definition for the media file. One or more tags may be used to identify the portion. In an embodiment, a tag may consist of text in the form of one or more words or phrases. Alternatively, an image such as an icon or a picture may be used. In yet another alternative embodiment, any combination of images, multimedia file or text may be selected and used as tags describing the identified portion. Such a multimedia file may include any combination of audio, video, text and images.

The tag or tags are selected by the creator and the selection is received via the creator's interface with the rendering device. Depending on the implementation, the tag or tags may be used to create tag information on the creator's rendering device or on a media server remote from the rendering device as discussed above.

The metadata and tag information are then stored in a store operation 410. Again, depending on the implementation, the metadata and tag information may be stored on the creator's rendering device or stored on a media server remote from the rendering device. In any case, the data is stored in such a way as to associate the metadata and tag information with the media file. For example, in an embodiment the metadata may include the name of the media file and the tags identified by the creator. In another embodiment, the name and location of the media file, the metadata and each tag may be stored in separate but associated records in a database. Other ways of associating the media file, metadata and tag information are also possible depending on the implementation of the system.

Method 400 is suitable for use with a pre-existing media file created without anticipation of a future portion definition. Method 400 is also suitable for adding one or more portion definitions to a media file that may already include or be associated with one or more previously created portion definitions.

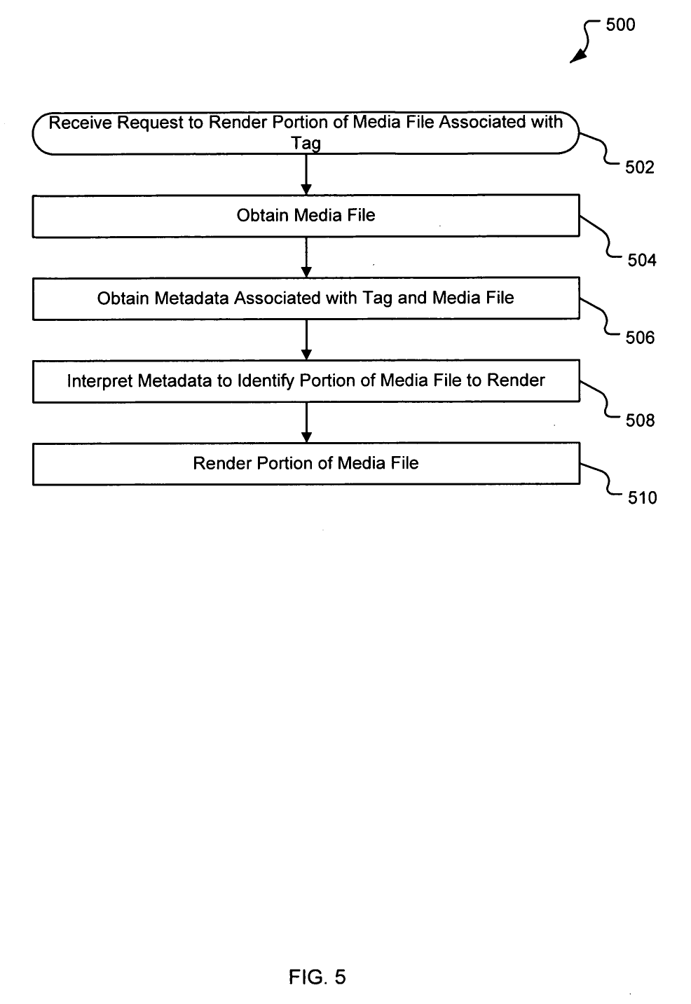

FIG. 5 is a flowchart of an embodiment 500 of a method of rendering only a portion of a pre-existing media file. The method 500 shown starts with the receipt of a command by a consumer to render only a portion of a pre-existing media file in a receive render request operation 502. The request may be generated by the consumer selecting, e.g., clicking on, a link on a web page displayed by a browser. Alternatively, the request may be generated by a consumer opening a file, such as a file written in .XML or some other markup language, that can be interpreted by a rendering device. Such a link or file for generating the request may display information to the consumer such a tag associated with the portion to be rendered.

In an embodiment, the request includes data that identifies the media file and also identifies metadata that can be interpreted to identify a portion of the media file. The metadata can be incorporated into the request itself or somehow identified by the request so that the metadata can be obtained. The request may also include tag information for identifying the metadata and thus identifying the portion of the media file to be rendered.

After receiving the request, the media file must be obtained in an obtain media file operation 504 unless the media file has already been obtained. Obtaining the media file may include retrieving the file from a remote server using a URL passed in the request. It should be noted that the media file is a pre-existing file that was created independently of the metadata or any tag information used in the method 500 to render only a portion of the media file.

The portion definition must also be obtained in an obtain metadata operation 506 unless the metadata is already available. For example, if the metadata was provided as part of the request to render, then the metadata has already been obtained and the obtain metadata operation 506 is superfluous. In an embodiment, the request received contains only some identifier which can be used to find the metadata, either on the rendering device or on a remote computing device such as a remoter server or a remote media server. In the embodiment, the metadata is obtained using the identifier.

The metadata is then interpreted in an interpret operation 508. The interpret operation 508 includes reading the metadata to identify the section of the associated media file to be rendered.

The media file is then rendered to the consumer in a render operation 510 by rendering only the section of the media file identified by the metadata. If the section is associated with a tag, the tag may be displayed to the consumer as part of the render operation 510.

It should be noted that the steps described above may be performed on a rendering device or a media server in any combination. For example, the request may be received by a rendering device which then obtains the metadata and media files, interprets the metadata and renders only the portion of the media file in accordance with the metadata. Alternatively, the request could be received by the rendering device and passed in some form or another to the media server (thus being received by both). The media server may then obtain the media file and the metadata, interpret the metadata and render the media file by transmitting a data stream (containing only the portion of the media file) to the rendering device, which then renders the stream. In this embodiment, only the receiving operation 502 and the rendering operation 510 can be said to occur, in whole or in part, at the rendering device.

Other embodiments are also contemplated. In an embodiment, the media server serves as a central depository of portion definitions and these definitions are maintained as discussed below. In response to a request from a rendering device to the media server, the media may respond by transmitting the portion definition if the rendering device is capable of interpreting it. Note that the metadata making up the portion definition on the server's data store may need to be modified or collected into a format that the rendering device can interpret. If the rendering device is not capable of interpreting the portion definition, the media server may then retrieve the media file and stream the identified media data to the rendering device as described above. This may include querying the rendering device to determine if the rendering device is capable of interpreting a portion definition or performing some other operation to determine which method to use, such as retrieving user information from a data store or inspecting data in the request that may include information identifying the capabilities of the rendering device, e.g., by identifying a browser, a media player or device type.

In another alternative embodiment, a consumer may select to obtain and indefinitely store a copy of the associated pre-existing media file on the consumer's local system. A rendering device may then maintain information indicating that the local copy of the pre-existing media file is to be used when rendering the portion in the future. This may include modifying a portion definition stored at the rendering device.

Sharing Portions of Media Files

In an embodiment of the present invention, the architecture of FIG. 2 can be used to create a central database, such as at the media server, to identify portions of pre-existing media files stored at remote locations, categorize or describe those portions using tags, and create a searchable index so that portions of files matching a given search criteria can be found and selectively rendered. The media server may also maintain the currency of the portion definitions and ensure that the media files associated with portion definitions are still available as some media files may be removed from the Internet or moved over time. The media server may also modify the portion definitions as it detects that media files are moved from one location on the Internet to another, such as to an archive.

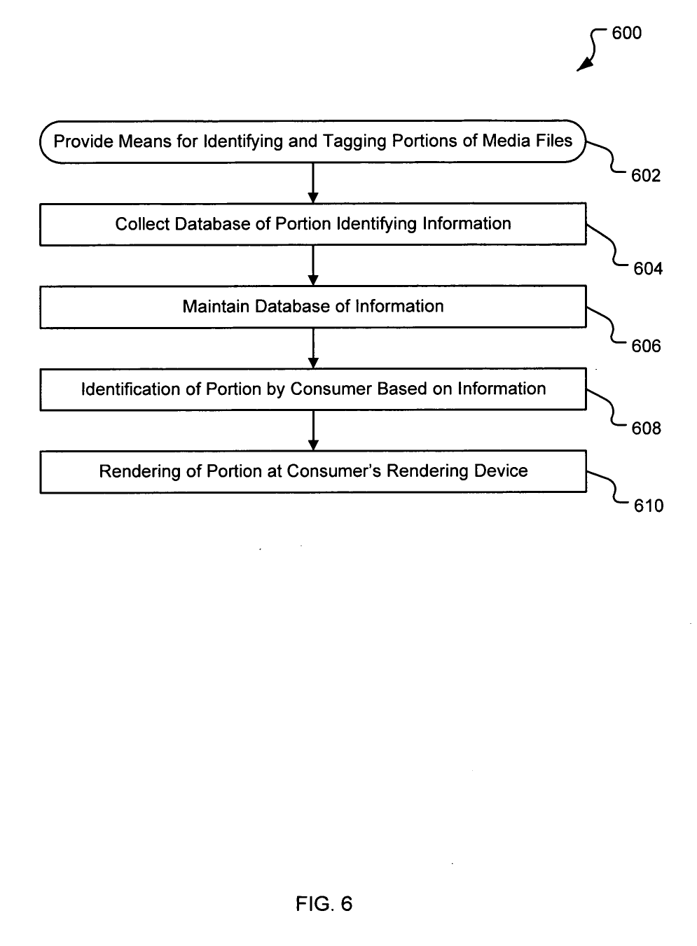

FIG. 6 is a flowchart of an embodiment 600 of a method of categorizing portions of pre-existing media files for selective rendering using a media server. In an embodiment the pre-existing media files are stored at remote locations accessible to consumers via one or more communications networks. For example, each pre-existing file may be stored on remote servers under control of the owner of the copyright for the pre-existing media file. Alternatively, the pre-existing media file may be stored locally at the media server.

The method 600 shown starts with providing a means to consumers to identify portions of a media file and associate the identified portions with a tag in provide identification system 602. A rendering device as described above is one means for identifying portions of a media file and associate the identified portions with a tag. Consumers may then render pre-existing media files obtained from third parties and identify and tag portions of the media file easily. Consumers performing this function are then the creators of the information that can be used to categorize or describe portions of the media files.

Next, the portion and tag information is collected in a collection operation 604. In an embodiment, the means provided as discussed above may also transmit the information, such as in the form of metadata associated with a media file, to a media server for storage. This allows information from multiple consumers to be collected into a single collection. In another embodiment, the information generated by the identification means may instead or may also be stored on a local rendering device.

In the embodiment shown in FIG. 6, the collected information is maintained in a storage system such as a database in a maintain operation 606. As discussed above, the database may be on a server computer or on a local rendering device. If information is received from multiple creators, the information may be collected in a single collection or database.

Maintain operation 606 may also include correlating information from different users. For example, information from different creators associated with the same media file may be modified, grouped or stored in a way that makes the information easier to search and require less storage space.

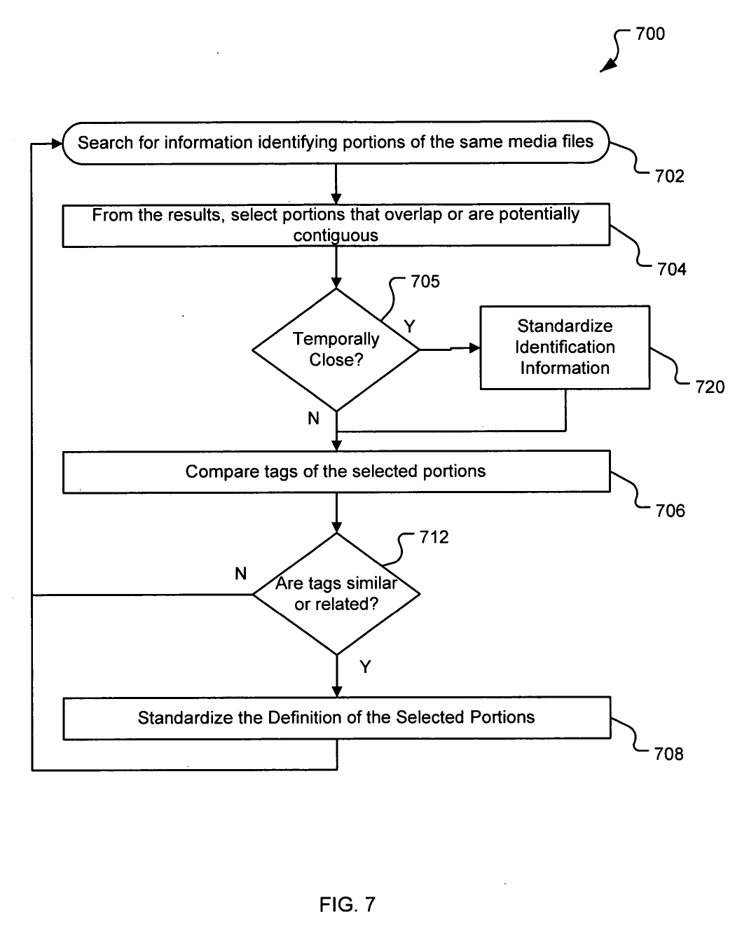

Additionally, information that identifies roughly similar portions of the same media file may be standardized. For example, three creators may identify a portion of the same media file and tag it with “weather”. However, as in one embodiment in which the exact moment that a creator makes a selection may indicate the start or end point of a portion, the sections identified are unlikely to start and end at exactly the same moment. An algorithm may be used to automatically standardize the portions so that multiple user tags may be linked associated with the same portions in the pre-existing media file even though the tags were developed by different creators. This is discussed in greater detail with reference to FIG. 7.

The information maintained on the database can be used to allow consumers to find and identify portions of pre-existing media files that are of interest, such as in the identification operation 608 as shown. The identification operation may include the use of search engine that searches the database for tags or other identifying information such as associated media file identifiers. Alternatively, potential consumers may be able to browse the information database by tag or by associated media file.

For example, identification operation 608 may include receiving a search request from a rendering device in which the request includes search criteria. The search engine then searches the database for portion definitions that match the search criteria. One element of the portion definition searched will be the tag information of the portion definition. If the tag information of a particular portion definition matches the search criteria (as determined by the internal algorithms of the search engine), a response may be transmitted to the source of the request that indicates that the portion identified by the particular portion definition matches the source's search criteria. In an embodiment, the response may take the form of a web page displayed to the source's user containing a list identifying the portion or a link through which the portion definition or information from the portion definition may be obtained from the database. In another embodiment, some or all of the portion definition may be transmitted to the source with the response so that a second operation need not be performed to obtain the portion definition.

Regardless of the implementation details, the system will allow the consumer to select a portion of a pre-existing media file for rendering based on the information in the database and displayed to the consumer.

In a rendering operation 610, the rendering is effected. The rendering operation 610 includes receiving a consumer selection and transmitting the information necessary to the consumer's rendering device to cause the selected portion of the media file to be rendered on the consumer's rendering device. This has been already been discussed in greater detail above, including with reference to FIG. 5.

FIG. 7 is a flowchart of an embodiment 700 of a method of collecting information identifying portions of pre-existing media files. The method 700 shown may be performed periodically, in response to the receipt of new data or continuously (as shown via the flow arrows returning to the first operation). The method 700 starts with a searching operation 702 that searches the database for identified portions associated with a common media file.

If two or more portions associated with a common media file are found, then the portions are inspected to determine if the portions are temporally close in a select operation 704. For example, the portions are inspected to determine if they overlap or alternatively end or begin at locations within the media file that are close when the file is rendered. In an embodiment, non-overlapping portions with start or end points within 5 minutes of each other when the media file is rendered may be considered temporally close; further, portions with start or end points within 1 minute of each other may be considered temporally close; yet further, portions with start or end points within 30 seconds of each other may be considered temporally close. If portions are found that are close or overlapping, the portions are selected for further analysis.

Portions selected in the select operation 704 are then evaluated in a proximity determination operation 705. The proximity determination operation 705 identifies locations, such as starting points and ending points, that so temporally close that it is likely there is a change in the content of the media file at that generally that location in the rendering of the file. For example, a weather forecast in a news report will have a specific beginning point. If a number of portions either begin, identify or end within a certain small period of time, it is likely they refer to the same point of content change in the media file. It is beneficial to find these point and identify them in a standard manner for all portions as it will aid in storing the portion information and presenting it to a potential consumer. In an embodiment, the system operator may select some threshold duration within which locations such as start or end points may be considered substantially the same location. For example, such a threshold may be 30 seconds, 15 seconds or 5 seconds. Further, the threshold may be different for each media file or based on a media file type. For example, in a news report, changes in subject may occur rather quickly and relatively smaller threshold may chosen than would be used in a continuous event such as a sporting event.

If the proximity determination operation 705 determines that a given location or locations do not overlap, then a subject matter comparison is performed in a comparison operation 706 discussed below.

However, if the proximity determination operation 705, based on the threshold duration, determines that locations in different portion information are likely referring to the same change in the underlying content of the media file, a standardization operation 720 is performed so that the close locations in the various selected portions are standardized to a single representation. This may involve overwriting the original identification information or maintaining the original information while identifying the locations as to be treated as a single point when displaying or other using the portion information in the future. The actual standardization can be done a number of ways, including selecting a weighted average location based on the original location information of the portions or selecting based on some other numerical distribution model. After standardization of the location based temporal proximity, the selected portions are then inspected in the compare operation 706 for subject matter relatedness.

The selected portions are compared in a compare operation 706. The compare operation 706 may look at the tags as well as any other information such as information related to the media file, other information identifying the portion, and information related to any associated tags.

Next, a determination operation 712 determines if the tags are similar or related in some way based on the results of the comparison. For example, tags such as “weather”, “current conditions” and “today's forecast” may be considered in certain circumstances to be related and likely to be generally referring to the same content in the media file. In these situations, it is beneficial to standardize the information identifying the portion so that, rather than categorizing or describing multiple different portions each with its own tag, one standardized portion is categorized or described multiple times with the various tags.

However, it is also possible that the tags are unrelated in that they refer to completely different aspects of the underlying content and just happen to share temporally close start or end points in the media file, or perhaps even overlap. For example, some part of a weather forecast in a media file may concern an interview with a scientist. Thus, one creator may identify the weather forecast and tag it with “weather” while another creator may identify only the portion of the weather forecast containing the interview and tag it with the scientist's name, in which case the tags may be determined to be unrelated and assumed to refer to different content.

If the subject matter relatedness determination operation 712 determines that the tags are similar or substantially related, then a tag standardization operation 708 is performed. If the portions are determined to be unrelated or to identify different content, then the method 700 ends and, in the embodiment of the method shown, returns to continue searching the database.

The subject matter relatedness determination operation 712 may involve two components. First, the determination may be used to identify related portions, but portions in which the various creators identified locations for the portions that are outside of the threshold used in the temporal proximity determination operation 705. Second, the determination may be used to determine if the portions as defined by the various creators, in fact refer to the same content in the media file, which may be assumed if the tags are substantially similar or related. If the tags are similar or related, then they are probably generally referring to the same content in the media file even though the various creators of the tags identified slightly different sections or locations in the media file when identifying the portions.

For portions so determined to probably refer to the same content, the tag standardization operation 708 modifies the information stored in the database to so indicate. This may involve overwriting or deleting some original identification information or maintaining the original information while identifying the portions as to be treated as a single portion when displaying or other using the portion information in the future. Thus, in an embodiment multiple portions in a database (each created by different creators and with different tag information and slightly different location information) may be combined into a single record having a single temporal description of the portion relative to the associated media file and a combination of the tag information from the individual records.

Composite Representations

The systems and methods described above allow for also support new ways of rendering media files. Another embodiment utilizes different portions to be combined to create a renderable composite representation of media files, without actually creating a media file. In the embodiment, a set of portions is combined in a way that indicates to a rendering device that the portions are to be rendered consecutively and in a prescribed order. For simplicity, such a set of portions will be referred to as a composite representation. In an embodiment, a composite representation may be a file, such as an XML file, that contains metadata identifying portions of media files as described above. The file may be read by a rendering device and, based on header or other identifying information in the file, cause the rendering device to render each identified portion in order, such as by repeating an embodiment of the method of rendering a portion of a media file (such as the one shown in FIG. 5) for each portion in the file in the order they appear.

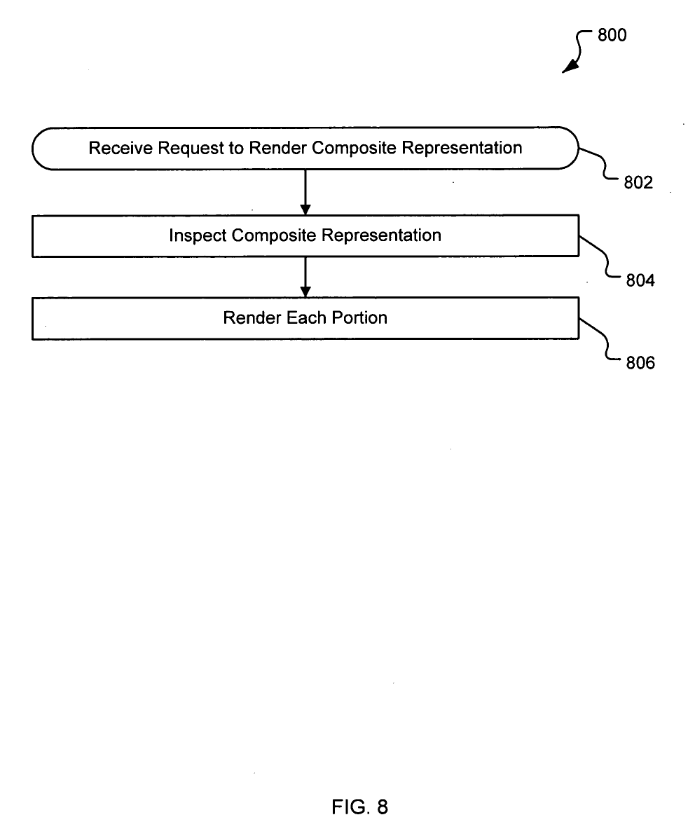

FIG. 8 is an embodiment 800 of a method of rendering a composite representation. In the method 800, a request is received to render the composite representation in a receive command operation 802. Depending on the form that the composite representation takes, e.g., a file, a link to a set of metadata, or a data contained in some larger element such as a web page, the actual command given by the consumer may differ. For example, if the composite representation is a file or a link, the consumer may initiate the request by selecting, clicking on, or executing the composite representation.

In response to the received command, the rendering device reads the composite representation in a inspect representation operation 804 and serially renders, in a render operation 804, the identified portions by performing the operations shown in FIG. 5 until all portions identified in the composite representation have been rendered.

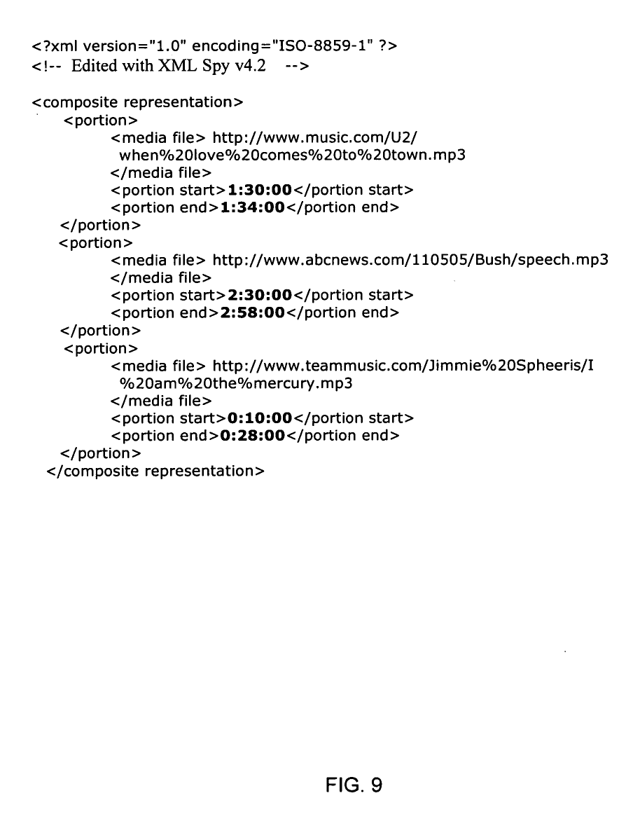

FIG. 9 is an example of an embodiment of a data structure of a composite representation. In the embodiment shown, the composite representation 900 is an .XML file having a header 902 identifying the XML version used. The composite representation 900 includes a data element 904 that identifies the XML file as a composite representation. This data element 904, may be used to indicate to the rendering device that multiple portions are defined in the file and that they are to be rendered in some order. If an order is not explicitly indicated in the information in the file, then a default order may be used such as the order in which the portions appear in the file.

The composite representation 900 also includes portion data elements 906, 908, 910 identifying one or more portions of media files. In the example shown, three portion data elements 906, 908, 910 are shown. Each portion data element 906, 908, 910 includes a media file identifier data element 912 identifying a media file. In the embodiment shown, all of the media files are stored on remote servers and the identifier is a URL for the media file associated with each portion. Each data element 906, 908, 910 also includes information in the form of a time stamp identifying the start of the portion and the end of the portion. In the embodiment shown, this information is contained in a start time data element 914 and an end time data element 916.

FIG. 9 illustrates an example of an XML file embodiment of a composite representation. Many other embodiments are possible as discussed above. Alternative embodiments may contain more or less information. For example, in other embodiments, additional information such as the composite representation's author and the composite representation's name may be provided. Alternative embodiments may use different data formats other than an independent XML file structure, such as data embedded in an electronic mail message or a hyperlink.

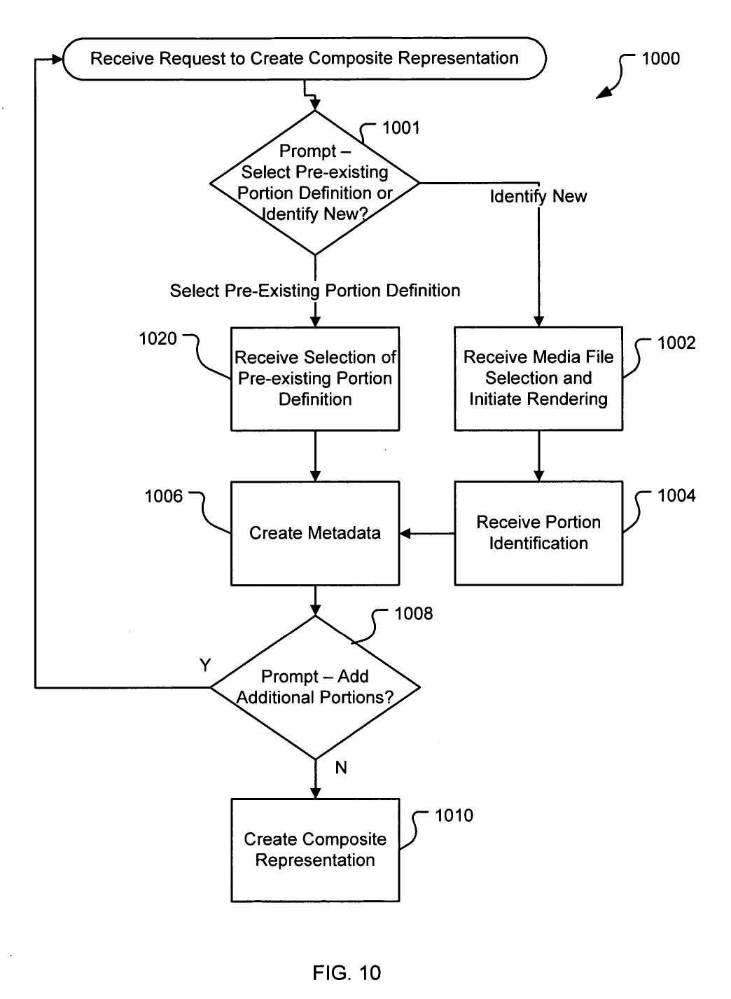

FIG. 10 is a flowchart of an embodiment 1000 of a method of creating a composite representation, in the form of metadata, identifying portions of different pre-existing media files to be played consecutively. In the method 1000 shown, in response to a request to create a composite representation from a creator, a first prompt operation 1001 prompts the creator to determine if the creator wants to select a pre-existing portion definition or to identify a new portion of a file to be included in the composite representation.

If the creator chooses to select a pre-existing portion definition, then a GUI for displaying portion definitions to the creator is displayed from which the creator makes a selection in a receive selection operation 1020. The GUI displayed to the creator will allow the creator to identify media files and see what pre-existing portion definitions exist for those media files. In one embodiment, the GUI is a portion definition search GUI such as that shown below with reference to FIG. 11 with the exception that instead of playing a selected portion, the portion definition metadata is obtained for later use.

If the creator chooses to identify a new portion of a media file, then media file rendering GUI is displayed to the creator from which the creator can select a media file and identify a portion of the media file. The creator starts play back of a selected media file using a rendering device capable of capturing the metadata in an initiate rendering operation 1002. The initiate rendering operation 1002 may be in response to receipt of a request to create a composite representation. The request may be received through a user interface of the rendering device from a creator. In a server-based system, the request may be transmitted from the rendering device to a media server.

During the rendering, the creator issues a request to the rendering device to identify a portion of the media file in an identify portion operation 1004. In an embodiment, the identify portion operation 1004 includes receiving a first command from the creator during rendering of the media file identifying the starting point and receiving a second command from the creator identifying an endpoint of the portion of the media file.

In an alternative embodiment, the creator issues a request to the rendering device to identify a location of the media file in an identify portion operation 1004. In this embodiment, only a first command from the creator is received during rendering of the media file identifying a location point within the media file. This command may then be interpreted as identifying all the media data in the file after the location or all the media data in the file before the location depending on a user response to a prompt, another user input or user defined default condition.

After a portion has been identified, either by selection in selection operation 1020 or by identification in identification operation, the appropriate metadata may be created or copied from a pre-existing portion definition in a create metadata operation 1006. Depending on the implementation, the metadata may be created on creator's rendering device or created on a media server remote from the rendering device as discussed above.

In the embodiment, after the create metadata operation 1006, the creator is prompted to determine if another portion definition should be added to the composite representation in a determination operation 1008. If the creator responds that the composite representation should include another portion definition, then the method 1000 returns to the initiate rendering operation 1002 and the previously described operations are repeated until the creator has identified all the portions of all the media files that the creator wishes to be played when the composite representation is rendered.

If the creator responds to the prompt in the determination operation 1008 that no further portions should be included, then a create composite representation operation 1010 is performed. In the create composite representation operation 1010, all the portion definitions created during the previous operations are collected and stored as required to create the composite representation. Depending on the implementation, the composite representation may be stored on the creator's rendering device or stored on a media server remote from the rendering device.

The composite representation may be associated with some description in a tag operation 1010. In an embodiment, the rendering device may prompt the creator to enter one or more tags, phrases or descriptions to be associated with the composite representation. In an alternative embodiment, the creator may enter the tag as part of an initial request to create a composite representation or a portion definition. For example, one or more tags may be used to identify each portion definition within the composite representation in addition to tags describing the composite representation. In an embodiment, a tag may consist of text in the form of one or more words or phrases. Alternatively, an image such as an icon or a picture may be used. In yet another alternative embodiment, any combination of images, multimedia file or text may be selected and used as tags describing the identified portion.

The tag or tags are selected by the creator and the selection is received via the creator's interface with the rendering device. Depending on the implementation, the tag or tags may be used to create tag information on the creator's rendering device or on a media server remote from the rendering device as discussed above.

The embodiments described with reference to FIGS. 8-10 together allow a renderable composite representation to be easily created by a creator, without editing or changing the original media files and without creating a new media file that contains any media content, protected or otherwise. This representation can then be easily transmitted to and rendered by consumers that have access to the various associated media files from the rendering device.

Filemarking

Yet another embodiment is a method and system for automatically marking a location in a media file, referred to herein as “filemarking” in allusion to the commonly known bookmark. In the embodiment, when a rendering device is given a command to stop rendering a media file, identification information may be automatically created by the rendering device. The identification information, such as metadata as described above, identifies the point in the media file that rendering was interrupted. In response to a later command by the consumer to render the same media file, the identification information may be accessed and the consumer may be prompted to determine if the consumer wishes to resume rendering from the point of interruption. Alternatively, the rendering device may automatically start rendering from the point of interruption.

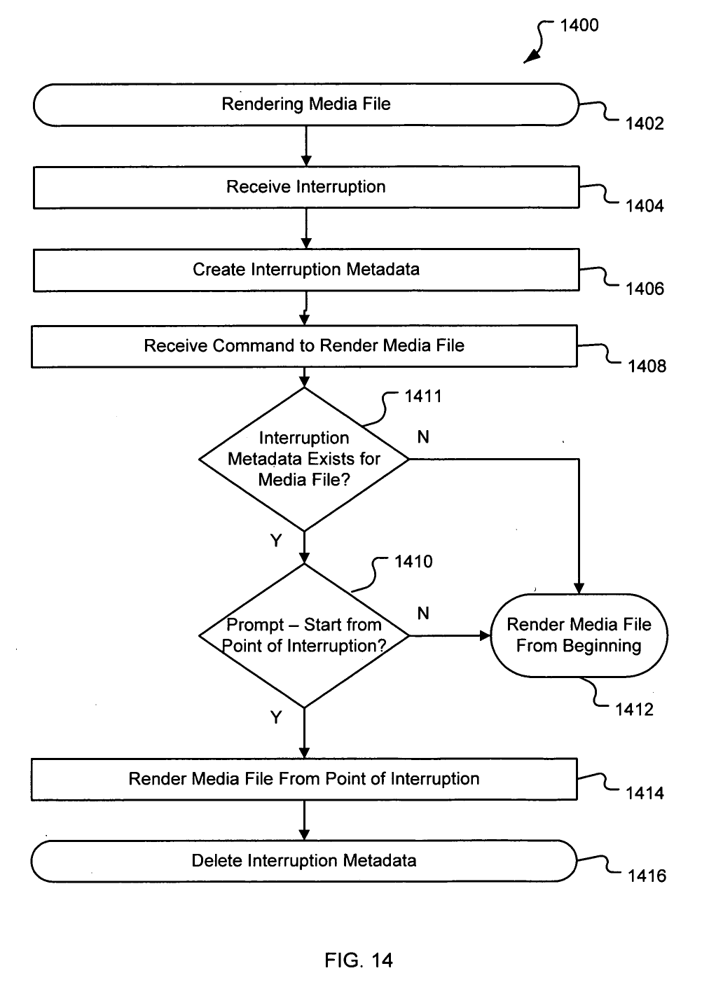

FIG. 14 is a flowchart of an embodiment 1400 of a method of rendering a media file using metadata to begin rendering the media file from the last location rendered. In the method 1400 a rendering device is rendering a media file in a render operation 1402. Render operation 1402 may include rendering the media file which is stored on the rendering device or may include rendering media data streaming to the rendering device from a media server.

At some point prior to the completion of the rendering of the media file, an interruption is received by the rendering device in receive interruption operation 1404. The interruption may be generated by a user command or by some other occurrence. For example, user commands that may cause an interruption include a command from a user of the rendering device to stop rendering the media file, to close a media player software application on the rendering device, to turn off the rendering device, or to render another media file. Examples of non-user generated interruptions include detection of a dropped connection to the media server (in the case of streaming media for example), a power failure of the rendering device, or a different software application taking control of the rendering device (such as an e-mail or telephone application alerting the user to an incoming communication).

When an interruption is received, metadata is created is a create metadata operation 1406. The metadata identifies the media file and a location within the media file at about the point that the interruption occurred. The location is said to be “at about” the point that the interruption occurred, because the location need only be near the proper location and need not be exactly the location of the interruption. As is the case with some media formats, it may not be possible to begin rendering from any given point and the location identified may be the nearest location from which rendering is feasible. The creation operation 1406 may include storing the metadata in a format such as a portion definition described above. Create operation 1406 may include storing the metadata on the rendering device. In a streaming embodiment, the metadata may also be created by and/or stored on the media server.

In the method 1400, at some time after the interruption and creation of the metadata, a command to render the media file, which may be generated by the user, is received by the rendering device in a receive command operation 1408. For an embodiment in which media data is streamed to the rendering device from a media server, the command may be further transmitted to the media server.

After the receive command operation 1408, the rendering device determines if there is metadata associated with the media file created from an interruption in a determination operation 1411. If there is no metadata, then the media file is rendered as normal in a begin render operation 1412.

If there is metadata, which may be stored on the rendering device or on the media server depending on the implementation, then a prompt operation 1410 presents a user interface from which the user may select to render the media file from the interruption location in the media file. If the user selects not to render from the interruption location, then the media file is rendered as normal in a begin render operation 1412.

If the user selects to render from the interruption location as determined by receiving a selection from the user, the media file is then rendered from about the location in the media file that the interruption occurred. In an embodiment in which the media file is stored on the rendering device, this may include reading the metadata and using the information identifying about the location of the interruption and initiating rendering of media data from the media file at the interruption location. In a streaming embodiment, this may include transmitting some or all of the metadata to the media server for the server to identify the interruption location and stream the appropriate media data.

After the rendering operation 1414, the metadata may be deleted in a delete interruption metadata operation 1416. Although not shown in the embodiment in FIG. 14, the interruption metadata delete operation 1416 may also be deleted after the render from beginning operation 1412. If there is a later interruption, new metadata may be created and the method 1400 may continue.

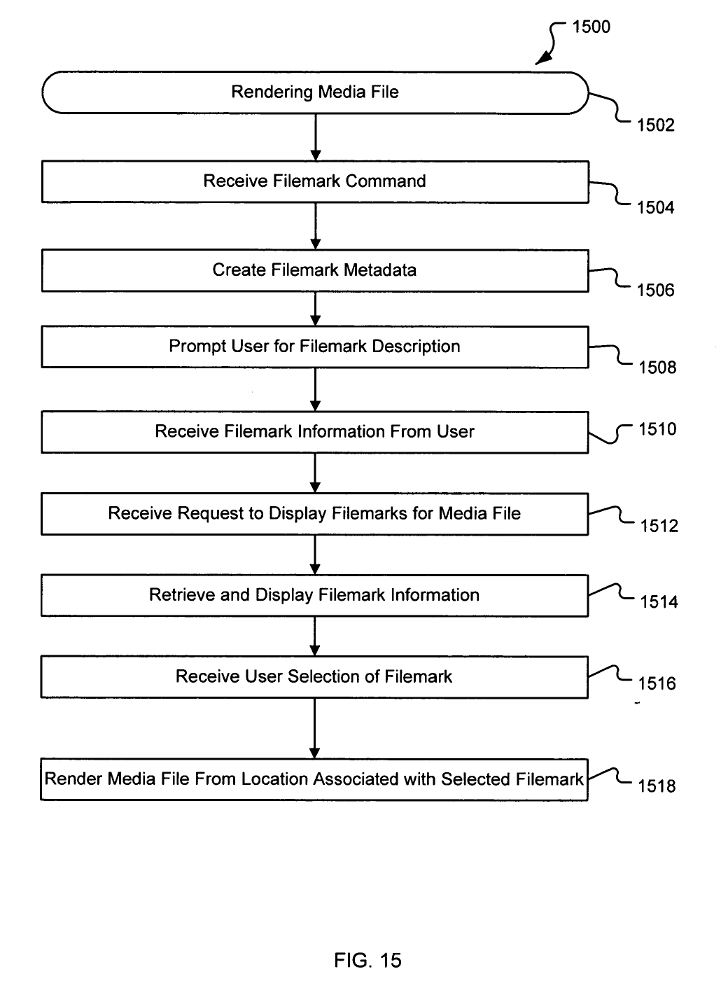

FIG. 15 is a flowchart of an embodiment 1500 of a method of filemarking a pre-existing media file without modifying the media file. In the method 1500, a consumer who wishes to make filemarks for a pre-existing media file renders the media file on a rendering device in an initial render operation 1502. The pre-existing media file may or may not already contain filemarks created according to method 1500.

At some point during the rendering of the media file, a filemark command is received from a user in a receive filemark command 1504. The command may be received in response to a user selecting a filemark control from a user interface displayed to the user during rendering of the media file.

In response to receipt of the filemark command, metadata associated with the media file identifying the about the location that the filemark command was received is created in a create filemark metadata operation 1506. The metadata may include information identifying the media file and may take the form of a portion definition as described above. The filemark command may or may not result in an interruption of the rendering of the media file.

Also in response to the receipt of the filemark command, the rendering device may prompt the user for filemark information to be associated with the location in the media file in a prompt operation 1508. Prompt operation may include a query to the user for some input, such as text, that describes the filemarked location. In response, the user may enter a filemark or notes regarding the location in the media file and this filemark information is received from the user in a receive filemark information operation 1510.

The filemark information and the filemark metadata are associated with the media file and may then be stored in a store operation. The filemark information and the filemark metadata may be stored together, such as in a portion definition. The filemark information and the filemark metadata may be stored in a data store on the rendering device, may be stored on a media server and associated with the user, or stored at both locations. Using the above listed operations, a user may create multiple filemarks for the same media file. In an embodiment, multiple filemarks associated with a single media file may be collected and stored as a single data structure.

At some time after the creation of one or more filemarks, a user may issue a request to the rendering device to display filemarks associated with the media file in a receive request to display filemarks operation 1512. This request may be received without rendering the media file. In an embodiment, such a request may be transmitted from a rendering device to a media server.

In response to the request, filemark information is retrieved from the data store and displayed to the user in a display filemark information operation 1514. The display allows the user to select a filemark, such as via a pointing device.

In response to receiving from the user a selection of a filemark in a receive filemark selection operation 1516, the media file is rendered from the filemark location in a render media file operation 1518 based on the information in the metadata associated with the filemark selected. This may include retrieving some or all of the metadata from the data store. In a streaming embodiment, some or all of the metadata may be transferred to a media server, which in turn streams the appropriate media data to the rendering device.

Note that the media file need not be stored on the rendering device to use this method 1500 to filemark media files. In render operation 1518, the media file may be retrieved from a remote location, such as content server. Based on the association of the filemark information and metadata with the media file, the rendering device is capable of maintaining and displaying the appropriate filemark information without the media file needing to reside on the rendering device or a media server in a streaming embodiment.

Graphical User Interface

FIG. 11 is an illustration of an embodiment of a graphical user interface of a rendering device. The graphical user interface (GUI) 1100 may be provided and displayed by media player software executing on the rendering device or may be provided by a media engine executing on a media server and displayed at the rendering device via a browser. The GUI 1100 includes controls in the form of text boxes, drop down menus and user selectable buttons to allow the searching for media files. In the embodiment shown, the searching is performed by the media server in response to a request generated in response to user commands given through the controls on the GUI 1100. In response to the commands, a search request is transmitted to the media server and its database is searched for matches to the search criteria.

GUI 1100 includes a first control in the form of a text box 1102 into which a user may enter search criteria in the form of text. The GUI 1100 further includes a second control 1104 in the form of a drop down menu allowing a search to be limited to search conditions selected from the drop down menu. The embodiment of the GUI 1100 is tailored to searching for podcasts. A podcast refers to an associated group (a series) of media files, referred to as episodes. Series and episodes may have different descriptions and thus are individually selectable to search. Thus, in the GUI 1100, the drop down menu control 1104 allows the user to search for only series matching a search criteria entered the text box control 1102. Likewise, a user may also select to search only for media files (i.e., episodes) or only for portions of episodes. The GUI 1100 further includes a control 1106 for initiating the search in the form of a selectable button displaying the text “Search”. In an embodiment, when the search button control 1106 is selected, such as by a mouse click, a shortcut keystroke or via some other user entry, a request is sent to the media server. If the “episode portions” limitation has been selected by the user through the drop down menu control 1104, then the request will be to search the data store for portion definitions matching the search criteria entered into the text box control 1102.

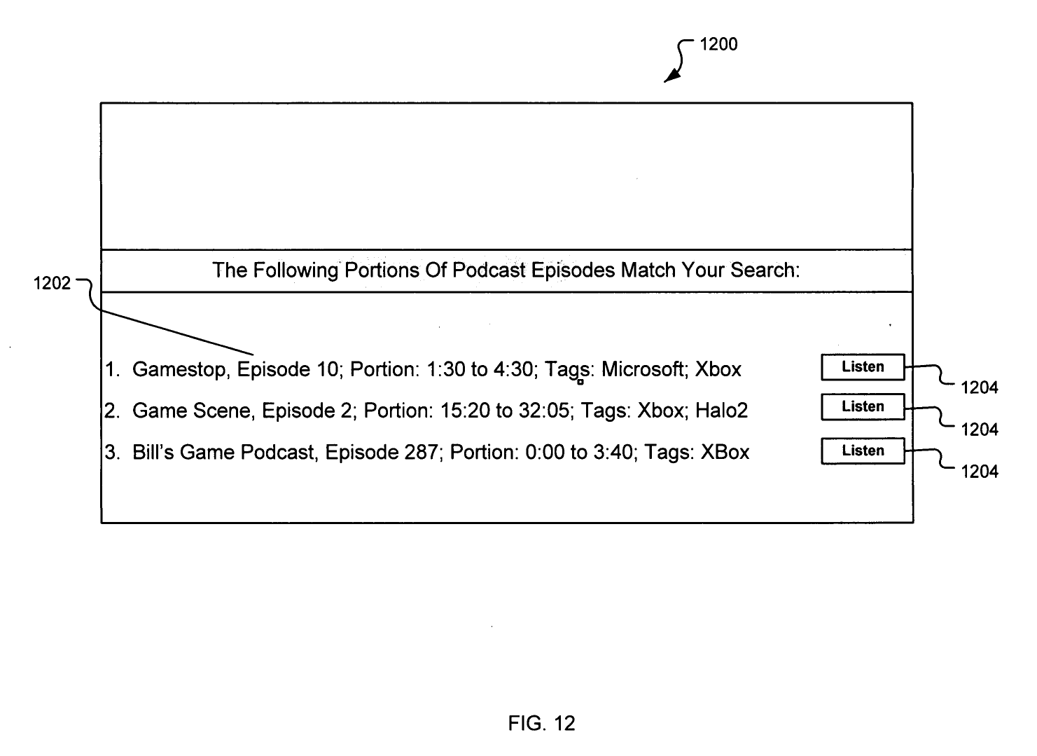

FIG. 12 is an illustration of an embodiment of a graphical user interface of a rendering device showing the results of a search for portions of media files. In the embodiment shown, the GUI 1200 may be displayed on the rendering device after a search for portions was performed as described above with reference to FIG. 11. The GUI 1200 contains a listing 1202 of entries, each entry identifying a portion of a media file. The information provided in the list may include the name of the media file (in the podcast embodiment shown, the name of the series and the name of the episode are included in the list), information identifying the portion of the media file matching the search criteria, and additional information specific to the portions listed. In the embodiment shown, the additional information specific to the portions listed consist of tags that have been previously provided by other consumers of the episode. In an alternative embodiment, the additional information may include a detailed description of the portion.

The GUI 1200 also includes a control 1204, associated with each entry in the listing, in the form of a selectable “Listen” button 1204. As described above, selection of one of these controls 1204 may result in the portion definition associated with the entry being transmitted to the rendering device or may result in the streaming of only the media data identified by the portion to the rendering device. In any case, selection of the “Listen” button 1204 will effect the rendering of only the portion of the media file associated with the entry.

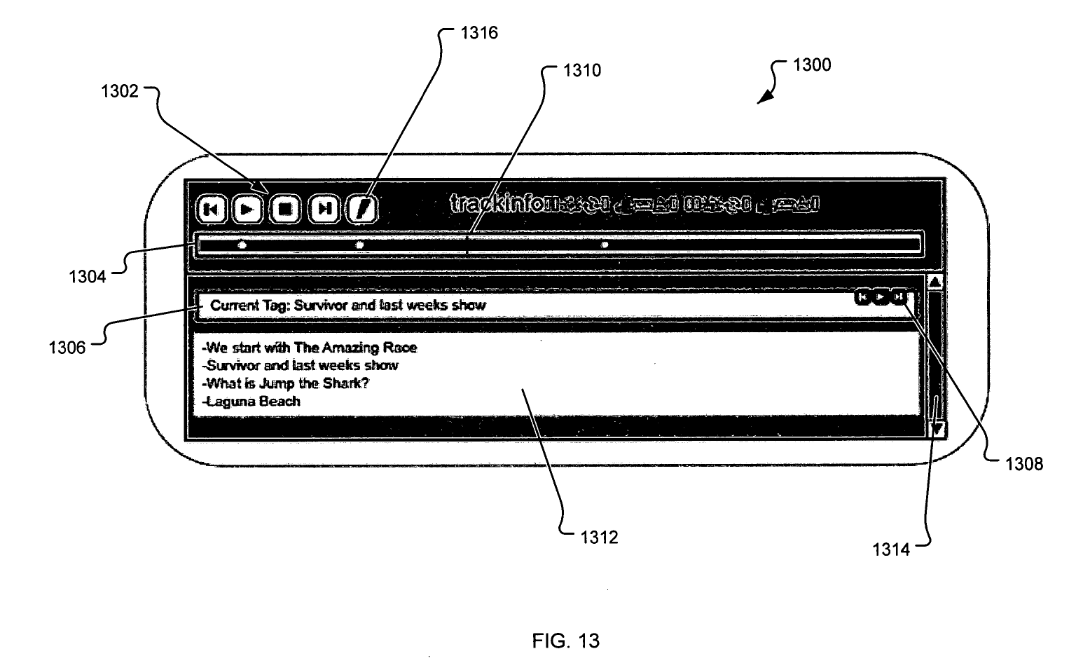

FIG. 13 is an illustration of an embodiment of a graphical user interface of a rendering device during rendering portions of media files. In the embodiment shown, the media file has been divided into several consecutive portions, each having its own associated tags. The GUI 1300 includes a set of media controls 1302 which, in the embodiment shown, include separate buttons for play, stop, forward and reverse that apply to the media file as a whole. A play bar control 1304 is also provided that shows, via a moving position identifier 1310, the current point in rendering of the media file. In addition, the play bar control 1304 also displays, in the form of circles within the bar 1304, the start and end locations within the media file associated with one or more portion definitions.

As mentioned above, in the embodiment shown, the media file being rendered has been previously divided into several consecutive portions. This information relating to different portions of the same media file may have been provided in a single portion definition on the rendering device, as may be created from the information collected via the method discussed with reference to FIG. 7. Alternatively, the tag may be information obtained from a plurality of portion definitions provided to the rendering device. In the embodiment, the various portions identified for the media file are displayed in a portion listing display 1312 which may be provided with one or more scroll bars 1314 as shown to facilitate display to the user of the rendering device.

In the play bar control 1304, the portion being currently rendered is highlighted and information associated with the portion is displayed in a separate current portion tag description field 1306 on the GUI. In the GUI 1300 shown, a second set of media controls 1308 which, in the embodiment shown, include separate buttons for play, forward and reverse are provided that are specific only to the identified portions of the media file. Depending on the implementation, selection of the back button in the second set of media controls 1308 results the rendering of only the portion identified in the portion tag description field 1306 from the beginning. Selection of the forward button in the second set of media controls 1308 results the rendering either the next portion known in the media file or identified in the portion tag description field 1306 from the beginning. As discussed above, selection may include use of a pointing device such as mouse click or use of a keyboard shortcut. For example, a quick key may be provided for identifying the beginning of a portion, identifying the end of a portion, adding a tag, and saving an identified portion. Such a shortcut key might pause the audio file, bring up a dialog box with fields such as “note”, “tags”, and “title”.

In an embodiment, a user may also initiate the rendering of any portion of the media file shown in the portion listing 1312 by directly selecting the portion listing, such as by clicking on an entry in the listing with a pointing device.

GUI 1300 also includes a tag button control 1316 for changing controls of the GUI 1300 into controls allowing the entry of new tags and definition of a portion of the media file to associate the tags with. In an embodiment, while rendering a media file upon selection of the button control 1316 a new circle location delimiter is shown on the play bar 1304 and the current portion tag description field 1306 become a text box for entering tags to be associated with the media file. A second selection of the tag button control 1316 or playing of the file to the end then causes the portion to be defined. Then depending on the embodiment, a new portion definition is created which may be transmitted to a media server for collection into a portion definition database or transmitted to another media consumer so that media consumer can render the portion of the media file along with the tag information just entered.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method of rendering a portion of media data within a media file, the portion excluding at least some of the media data within the media file and the method comprising:
accessing a portion definition associated with the media file, the portion definition identifying the portion of media data within the media file to be rendered;
accessing the media file; and
in response to a command to render the media file in accordance with the portion definition, rendering by the rendering device only the portion of media data.

2. The method of claim 1 wherein the command to render comprises a request to render media data in the media file associated with a tag and the method further comprises:
receiving a search request to identify media files associated with the tag;
displaying the media file as having media data associated with the tag; and
receiving the request to render the media file.

3. The method of claim 1 wherein accessing the media file further comprises:
requesting the media file from a remote computing device based on information contained in the portion definition; and
receiving a copy of the media file from the remote computer.

4. The method of claim 1 wherein accessing the portion definition further comprises:
retrieving, from a remote location on the network different from the remote location of the media file, a copy of the portion definition.

5. The method of claim 1 wherein the portion definition includes information identifying a starting point and an ending point within the media file and rendering further comprises:
rendering the media file only from the starting point to the ending point in response to the command.

6. The method of claim 1 wherein the portion definition identifies a discrete location within the media file and rendering further comprises:
rendering, in response to the command, the media file starting at the discrete location.

7. The method of claim 1 wherein the portion definition includes tag information associated with and describing the portion of the media file and rendering further comprises:
extracting the tag information associated with and describing the portion of the media file from the metadata;
displaying at least some of the tag information while rendering the portion of the media file.

8. The method of claim 1 further comprising:
displaying, while rendering the portion of the media file, information from the media file; and
displaying, while rendering the portion of the media file, information from the portion definition.

9. The method of claim 1, wherein the portion definition includes information identifying its associated media file including a network location of the media file, information identifying the portion of media data within the media file including at least one location identifier identifying a location within the media file, and information describing the media data to a potential consumer of the media file.

10. A computer-readable medium having computer-executable instructions for rendering a portion of media data within a media file, the portion excluding at least some of the media data within the media file and the computer-executable instructions comprising instructions for:
accessing a portion definition associated with the media file, the portion definition identifying the portion of media data within the media file to be rendered;
accessing the media file; and
in response to a command to render the media file in accordance with the portion definition, rendering by the rendering device only the portion of media data.

11. The computer-readable medium of claim 10 wherein the command to render comprises a request to render media data in the media file associated with a tag and the method further comprises instructions for:
receiving a search request to identify media files associated with the tag;
displaying the media file as having media data associated with the tag; and
receiving the request to render the media file.

12. The computer-readable medium of claim 10 wherein accessing the media file further comprises instructions for:
requesting the media file from a remote computing device based on information contained in the portion identifier; and
receiving a copy of the media file from the remote computer.

13. The computer-readable medium of claim 10 wherein copying the metadata further comprises instructions for:
retrieving, from a remote location on the network different from the remote location of the media file, a copy of the portion definition.

14. The computer-readable medium of claim 10 wherein the portion definition identifies a section of media data having a starting point and an ending point within the media file and rendering further comprises instructions for:
rendering only the section of the media data in response to the command.

15. A system for rendering only a portion of media data within a media file, the portion excluding at least some of the media data within the media file and the system comprising:
the media file;
a portion definition associated with the media file, the portion definition identifying the portion of media data within the media file to be rendered; and
a rendering device adapted to render media files and further adapted to interpret portion definitions and render only the portion of media data within the associated media file identified by the portion definition.

16. The system of claim 15 wherein the rendering device is further adapted to retrieve, from a remote computing device, a media file associated with a portion definition in response to a command to render the portion definition.

17. The system of claim 15 wherein the rendering device further comprises:
a general purpose computing device capable of executing software modules; and
a media player software module.

18. The system of claim 15 wherein the rendering device further comprises:
a browser software module adapted to retrieve media files and portion definitions from a network of computing devices.

19. The system of claim 18 wherein the rendering device is further adapted to retrieve, from a remote computing device, the portion definition in response to a consumer request to render a link displayed by the browser, the link associated with the portion definition.

20. The system of claim 19 wherein the rendering device is further adapted to display a graphical user interface, the graphical user interface displaying information from the media file when rendering only the portion of media data identified by the portion definition in response to a request to render the media file in accordance with the portion definition.
